(19) United States
(12) Patent Application Publication
(10) Pub. No.: US 2007/0067938 A1
(43) Pub. Date: Mar. 29, 2007

(54) Wiper system for wiping a windscreen

(76) Inventor: Joachim Zimmer, Sasbach (DE)

Correspondence Address: MICHAEL BEST & FRIEDRICH, LLP, 100 E WISCONSIN AVENUE, MILWAUKEE, WI, 53202, US

(21) Appl. No.: 10/579,646

(22) PCT Filed: Nov. 4, 2004
(86) PCT No.: PCT/DE04/02435

§ 371 Date: May 18, 2006

(30) Foreign Application Priority Data
Dec. 29, 2003 (DE) 103 61 746.9

(51) Int. Cl. B60S 1/24; B60S 1/34; B60S 1/36

(52) U.S. Cl. 15/250.21; 15/250.31

(57) ABSTRACT

The invention relates to a wiper device (1) to wipe a windshield (5) of a motor vehicle with a wiper arm (10) and two connecting rod levers (8), wherein the connecting rod levers (8) are connected to the wiper arm (10) in a plane at fastening points (9) so they can move rotationally, wherein at least one of the connecting rod levers (8) is executed to be elastic essentially perpendicular to the wiper plane in order to effect a pressure force from the wiper arm (10) on the windshield.

### BACKGROUND OF THE INVENTION

The invention relates to a wiper device to wipe a windshield, in particular a wiper device with wiper arm lift control.

In order to enlarge the wiped area of wiper devices, wiper arm lift controls are used, particularly in the form of four-bar wiper arms. Four-bar wiper arms essentially feature two connecting rod levers in addition to the actual wiper arm, each of which are connected to the wiper arm via an articulation. Because of an appropriate kinematic design, the wiper arm exerts a lifting and swiveling movement when the connecting rod levers are swiveled. Driving the four-bar wiper arm is accomplished via one of the two connecting rod levers, which as a drive lever is equipped with an electric drive. The second connecting rod lever, the control lever, is used to affect the lift of the wiper arm and is only fastened to a blind bearing, which does not transmit any torque.

The bearing force of the wiper arm on the windshield is normally generated by a tension spring. For this purpose, the wiper arm features a wiper arm articulation, wherein the tension spring is arranged in the articulation area of a two-piece wiper arm. While a coupling piece of the two-piece wiper arm is connected to the connecting rod levers, the wiper blade is arranged on the articulation part, and the wiper blade is pressed against the windshield with the aid of the tension spring. Alternatively, the pressure force of the wiper blade is generated with a compression spring, which is arranged in the articulation area of the wiper arm.

Providing the articulation in the wiper arm produces a relatively high design of the wiper arm in order to achieve sufficient rigidity in the area of the articulation. In addition, the tension springs and their fastenings require construction space, which increases the height of the wiper arm in the perpendicular direction with respect to the windshield.

In addition, the articulation normally has play, which increases further in the case of longer use of the wiper arm. This leads to a reduction in the service life of the wiper arm and can produce rattling and/or overshooting at the wiper arm's reversing positions.

### SUMMARY OF THE INVENTION

It is the objective of the present invention to make available a four-bar wiper arm that is as flat as possible, which can be manufactured cost-effectively and has a favorable wear behavior.

In accordance with the invention, a wiper device to wipe a windshield of a motor vehicle is provided that features a wiper arm and two connecting rod levers. The connecting rod levers are connected to the wiper arm in a plane at fastening points so they can move rotationally. At least one of the connecting rod levers is executed to be elastic essentially perpendicular to the wiper plane in order to effect a pressure force from the wiper arm on the windshield in an installed state.

One idea of the present invention consists of making a four-bar wiper device available in which the requirement for the construction height of the wiper arm is reduced since the pressure force of the wiper arm or of the wiper location connected to the wiper arm is effected on the windshield via one or both connecting rod levers. The wiper arm can be embodied to be non-articulated in particularly due to the elastic design of the connecting rod lever since the pressure force is made available via the connecting rod lever. As a result, providing articulation in the wiper arm is dispensed with in a simple way as well as a corresponding tension or compression spring, which generates the pressure force on the windshield in embodiments in accordance with the prior art. Because the articulation is dispensed with, the construction height of the wiper arm can thereby be reduced and the wiper device is less susceptible to wear.

In addition, manufacturing is greatly simplified since the connecting rod lever can be embodied as a bar spring element.

In particular one of the connecting rod levers can be embodied as a drive lever and another of the connecting rod levers as a control level, wherein the wiper arm is swiveled and lifted by swiveling the drive lever around a swivel axis.

In order to achieve a pressure force from the wiper arm on the windshield, at least one of the connecting rod levers is pre-stressed in an installed state.

The connecting rod levers can each feature a fold-out mechanism in order to swivel the wiper arm into a maintenance position so that a wiper connected to the wiper arm can be serviced or replaced. In this case, the connecting rod levers are designed such that in the maintenance position they are able to project at an angle from the wiper plane or the windshield so the wiper arm is no longer resting on it and is therefore accessible.

The connecting rod levers can each feature a snap-in device in order to hold the connecting rod levers in the maintenance position, wherein the connecting rod levers are designed such that they are able to exit the maintenance position by moving the connecting rod levers back into the wiper plane via the exertion of a restoring force.

According to another embodiment, the connecting rod levers are made of a deep-drawing material in order to be able to manufacture them as simply as possible, e.g., using a stamping process.

In particular the connecting rod levers can be coupled with the wiper arm and/or with the swivel axes at the fastening points with the aid of a caulked fastening element.

### BRIEF DESCRIPTION OF THE DRAWINGS

Preferred embodiments of the present invention are explained in more detail in the following on the basis of the enclosed drawings. They show:

FIG. 1 An arrangement of a four-bar wiper device on a motor vehicle in accordance with the prior art.

FIG. 2 A depiction of the rear of the wiper device for a four-bar wiper system in accordance with the prior art.

FIG. 3 A four-bar wiper device in accordance with a first embodiment of the present invention.

FIG. 4 An embodiment of a fastening point between the connecting rod lever and the wiper arm.

FIG. 5 A depiction of a fastening of the connecting rod lever at its swivel axis.

FIG. 6a and 6b Depictions of a connecting rod lever with fastening elements and bearing bolts in an unstressed and installed state.

FIG. 7 Another embodiment of the fastening element at the swivel axis.

FIG. 8 Another embodiment of a wiper device with overlapped fastening parts.

FIG. 9 A depiction of a connecting rod lever with an integrated fold-out mechanism.

### DETAILED DESCRIPTION

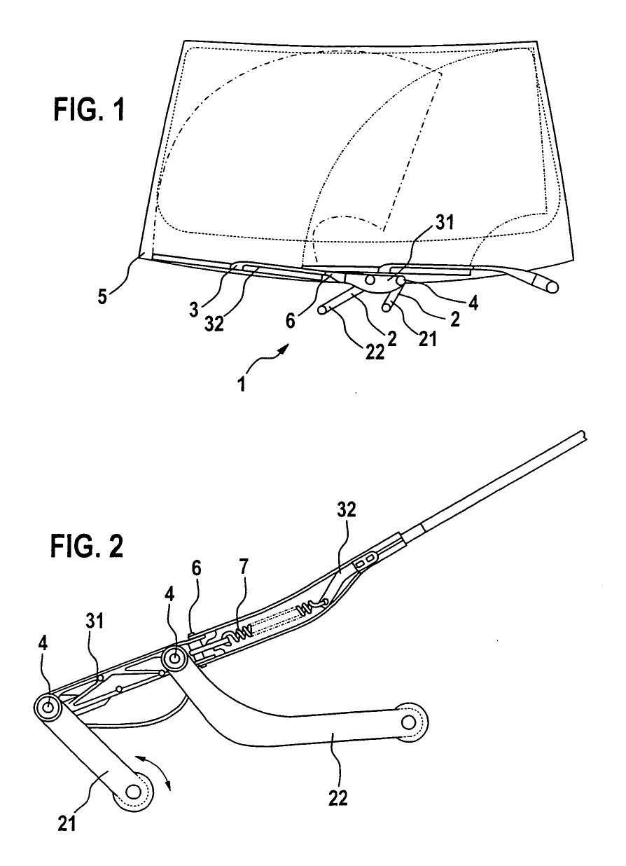

FIG. 1 depicts a wiper system like those that are used nowadays in motor vehicles. It has a wiper device 1, which is embodied as a four-bar wiper device. The four-bar wiper device features two connecting rod levers 2 with drive lever 21 and a control level 22, which are connected to a wiper arm 3 via fastening points 4. When the wiper arm 3 swivels, because of the support by the control lever 22 a lifting movement of the wiper arm 3 can occur along with the swivel movement so that the entire wiped area on the windshield 5 is increased. Driving the wiper arm 3 takes place in that the drive lever 21 is swiveled around its swivel axis 11. The control 22 effects the lifting movement of the wiper arm 3.

As can be seen in the depiction of the rear of the wiper device in FIG. 2, the wiper arm 3 has an articulation 6, which connects the coupling piece 31 and the articulated arm 32 of the wiper arm 3 with one another. A spring element is attached to the articulation 6 in such a way that is presses the articulated arm 32 of the wiper arm 3 against the windshield 5.

The articulation 6 in the wiper arm 3 is disadvantageous because it is subject to wear, which reduces its service life and produces rattling and overshooting in the reversing positions. This especially reduces the service life of the wiper arm so that it has to be replaced frequently.

FIG. 2 shows the spring element 7, which is accommodated in the wiper arm 3 that is embodied with a U-shaped cross-section. The dimensions of the spring element 7 essentially prescribe the construction height of the wiper arm 3.

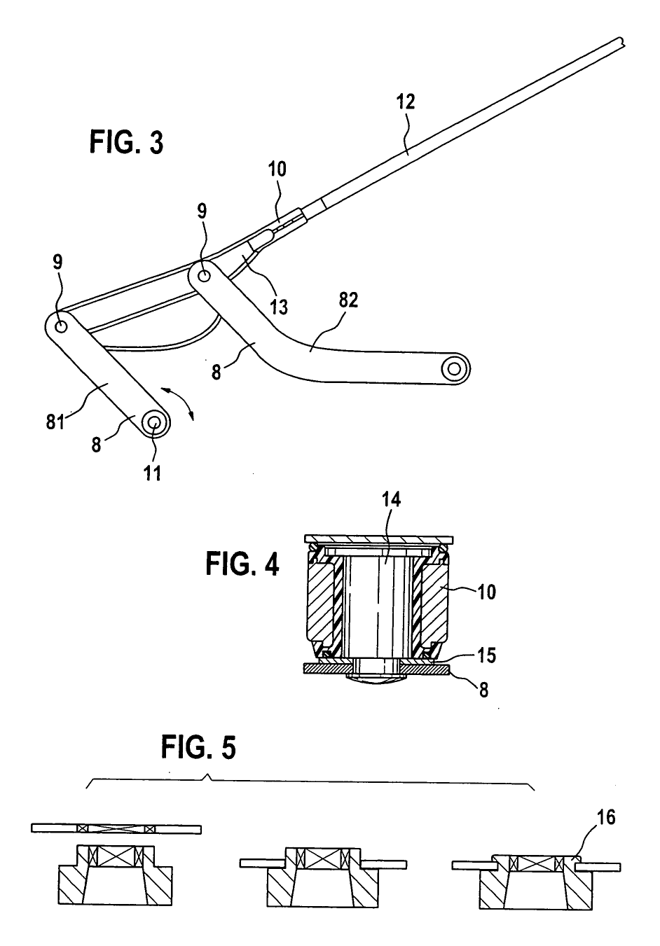

FIG. 3 depicts a wiper device in accordance with a first embodiment of the invention. The wiper device 1 features two connecting rod levers 81, 82, which are connected to a wiper arm 10 at the fastening points 9. In contrast to the embodiment in accordance with the prior art, the wiper arm 10 does not feature articulation in order to generate the pressure force on the windshield 5. While the wiper arm 10 is embodied to be as rigid as possible, the connecting rod levers 81, 82 are designed to be elastic, and are mounted under pre-stress such that the pressure force is essentially generated completely by the connecting rod levers 81, 82. Of course, it is also possible to provide for the pressure force to be generated by a bracing of the connecting rod levers 81, 82 and the wiper arm 10.

In particular, the connecting rod levers 81, 82 are embodied as a drive lever 81 and as a control lever 82 in order to achieve the swivel and lifting movement of the wiper arm 10. The drive lever 81 has a swivel axis 11, where the electrical drive (not shown) of the wiper device engages and enables the movement of wiper device by a swiveling of the drive lever 81.

The connecting rod levers 8 are connected to the wiper arm 10 at the fastening points 9 so that they can move rotationally, i.e., torque cannot be transmitted between the connecting rod lever 8 and the wiper arm 10 essentially in one direction parallel to the wiper plane. The fastening points 9 are embodied in such a way, however, that the pre-stress force, which the pre-stressed connecting rod levers 8 exert on the wiper arm 10, presses the wiper arm 10 on the windshield 5.

Because of the lack of articulation on the wiper arm 10, it can be provided with a smaller construction height so that the flow of the wiper blade, which is rigidly connected to the wiper arm 10, progresses undisturbed. The coupling between the wiper blade 12 and the wiper arm 10 is achieved via a coupling element 13, which can be embodied in various ways and is used to connect the wiper arm 10 and the wiper blade 12 as rigidly as possible to one another via a swivel joint.

FIG. 4 depicts an example of the connection between the connecting rod levers 8 and the wiper arm 10 at the fastening point. The depiction shows that the wiper arm 10 is connected to the connecting rod levers 8 via a fastening bolt 14 so that it can move rotationally, wherein a slide plate 15 is arranged between the respective connecting rod lever 8 and the wiper arm 10 in order to achieve the lowest possible friction when operating the wiper device. The fastening bolt 14 reaches through a corresponding bore hole in the connecting rod lever 8 and is riveted to it. The bearing between the connecting rod levers 8 and the wiper arm 10 can be executed as a plastic pivoting bearing or as a bearing with a riveted-on roller bearing. Both bearings are preferably embodied as cylindrical bearings with only one degree of rotational freedom.

FIG. 5 depicts the fastening of the connecting rod lever 8 at its swivel axis. For this purpose, the respective connecting rod lever 8 features an opening through which a fastening element 16 projects, which is caulked after assembly so that the connecting rod lever 8 is held securely at the fastening element 16 against swiveling. The opening in the case of the drive lever 81 is preferably angular, executed in accordance with the shape of the fastening element 16 in order to be able to transmit the torque of the electric wiper drive (not shown).

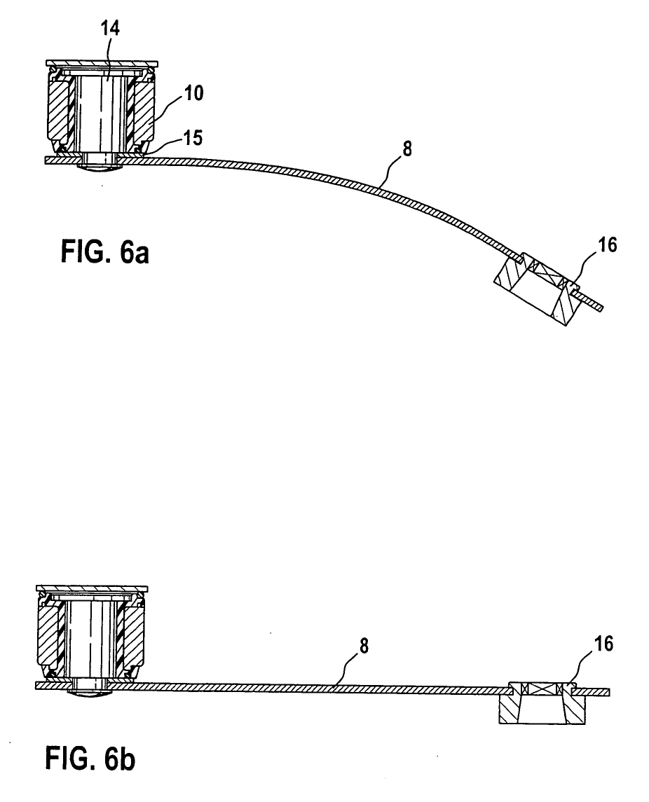

FIGS. 6a and 6b depict a connecting rod lever 8 in an uninstalled and an installed state. One can see that the connecting rod lever in the uninstalled state has a curvature, and is essentially straight in the installed state so that the connecting rod lever 8 in an installed state is strongly braced as compared with the uninstalled state. The bracing of the connecting rod lever 8 effects the pressure force of the wiper arm 10 so that additional measures to generate a pressure force in the wiper arm 10 are not required. The connecting rod levers 8 are preferably executed geometrically as a bar spring element in such a way that the required bearing force for the wiper blade 12 is generated on the vehicle via the respective pre-stressing in a mounted state. In the case of bearing force being generated by the drive lever 81 and control lever 82, the pre-stress force on both connecting rod levers 8 is divided approximately in half in order to avoid an unnecessarily high stress of the fastening with the swivel axis 11 and at the fastening points 9. The elastic connecting rod levers 8 absorb the lifting movements of the wiper blade 12, e.g., due to the curvature of the windshield 5.

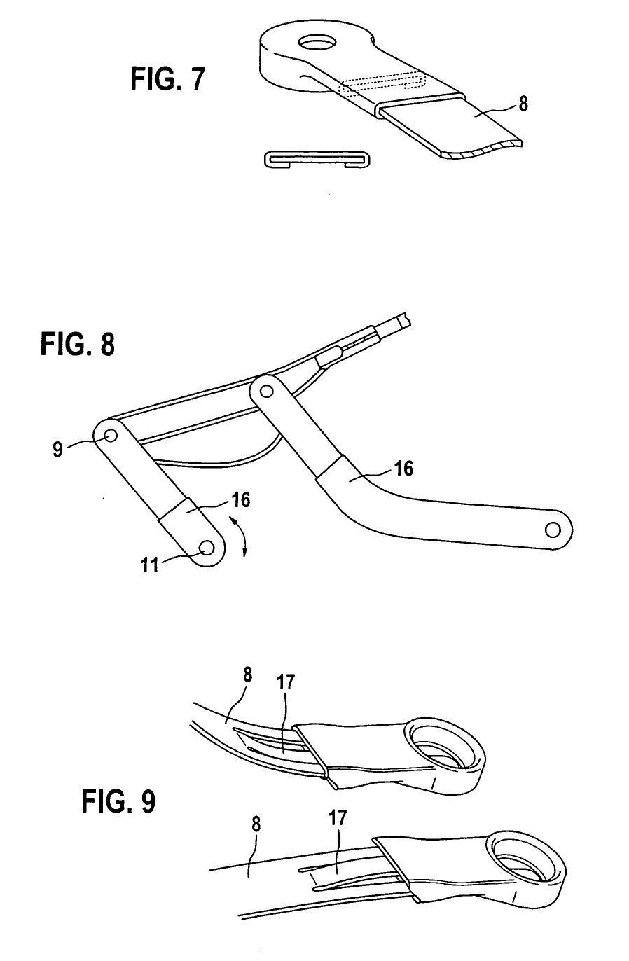

Another embodiment of the connecting rod lever 8 is depicted in FIG. 7. In order to reduce the bending near the swivel axis and thus the bending load there, the connecting rod lever 8 is overlapped with a sheet metal fastening part in a section facing the swivel axis. For one thing, the torque of the drive can be transmitted via this sheet metal fastening part and secondly, the spring tension when bracing the connecting rod lever 8 can be precisely set via the length of the overlapping.

As shown in FIG. 8, in particular both the drive lever 81 and the control lever 82 are overlapped with sheet metal fastening parts 16 in such a way that the spring tension is essentially brought about only via the non-overlapped sections of the drive lever 81 and the control lever 82; in order to effect the most uniform spring tension possible via the drive lever 81 and the control lever 82 that are normally of different lengths, the non-overlapped sections of the connecting rod levers 8 are embodied to have the same cross-section and the same length as much as possible. Instead of the overlapping sheet metal fastening part 16, the connecting rod levers 8 can also be embodied with different cross-sections, in particular with a larger cross-section for the section facing the swivel axis 11 and a smaller cross-section for the section facing the fastening point 9. By selecting the ratio between the sections of the connecting rod levers 8 facing the fastening points, the portion of the pressure force of each connecting rod lever 8 can be adjusted.

FIG. 9 depicts a fold-out mechanism, which makes it possible to put the wiper device into a maintenance position via a tensile force in the direction of the pre-stressing of the connecting rod levers 8 in that the connecting rod levers 8 lock into a secured state. For this purpose, the connecting rod levers 8 are provided with a “hair clasp mechanism”, i.e., with a securing element 17, which snaps back and forth between two secured states and which holds the connecting rod lever 8 in an operating position in a first secured state and in its second secured state allows the connecting rod lever 8 to project from the wiper plane against its pre-stress so that the wiper blade 12 that is fastened to the wiper arm 10 is released and does not rest on the windshield 5 so that the wiper blade 12 can be serviced or replaced.

The hair clasp mechanism can be integrated into the connecting rod levers 8 when embodying the connecting rod levers 8 as a stamped part; in particular with the use of such a fold-out mechanism, it is necessary to move the connecting rod levers 8 and the wiper arm 12 into a wiper blade change position in which both connecting rod levers 8 or connecting rod lever sections, which can be folded out with the hair clasp mechanism, lie essentially parallel to one another so that both connecting rod levers 8 are not twisted against each other during fold-out.

The connecting rod levers 8 can be manufactured in a simple manner as a stamped part, which can be brought into the curvature depicted in FIG. 6a using suitable methods so that a spring tension is effected when bending back the connecting rod levers 8. Other possibilities of embodying the connecting rod levers 8 in such a way that they have a pre-stress during installation in a wiper device are also conceivable. Depending upon the thickness of the connecting rod lever 8 it can be meaningful to reinforce the connecting rod lever 8 at the connection between the swivel axis 11 and the connecting rod lever 8 or between the fastening point 9 and the connecting rod lever 8 with suitable supporting elements since the connecting rod levers 8 can absorb only low bending forces at these locations because of the bore hole present at these locations. In particular, a bending at these locations because of the pre-stress of the connecting rod lever should be avoided.

In particular, an embodiment of the connecting rod lever 8 made of spring steel is meaningful.

An essential advantage of the present invention is that it is possible to build the wiper device with a lower construction height since an articulation in the wiper arm can be dispensed with. In addition, this results in less wear since the wiper arm is rigid and therefore no rattling or overshooting can occur in the reversing positions from play in the articulation in the wiper arm. The flat design is also advantageous for increased safety, e.g., with respect to protecting pedestrians in an impact. Particularly when using aero wiper blades, the wiper arm can be accommodated more simply in narrow hood gaps in the front panel because of the flat design.

1. Wiper device (1) to wipe a windshield (5) of a motor vehicle with a wiper arm (10) and two connecting rod levers (8), wherein the connecting rod levers (8) are connected to the wiper arm (10) in a plane at fastening points (9) so they can move rotationally, wherein at least one of the connecting rod levers (8) is executed to be elastic essentially perpendicular to the wiper plane in order to effect a pressure force from the wiper arm (10) on the windshield.

2. Wiper device (1) according to claim 1, wherein one of the connecting rod levers (8) is a drive lever (81) and another of the connecting rod levers (8) is a control level (82), wherein the wiper arm (10) is moved by swiveling the drive lever (81) around a swivel axis (11).

3. Wiper device (1) according to claim 1, wherein the wiper arm is designed to be non-articulated.

4. Wiper device according to claim 1, wherein at least one of the connecting rod levers (8) is pre-stressed in an installed state.

5. Wiper device (1) according to claim 1, wherein the wiper arm (10) is connected to a wiper blade (12) via a swivel joint.

6. Wiper device (1) according to claim 1, wherein the connecting rod levers (8) each feature a fold-out mechanism in order to swivel the wiper arm (10) into a maintenance position so that a wiper blade (12) connected to the wiper arm (10) can be serviced or replaced, wherein the connecting rod levers (8) are designed such that in the maintenance position they are able to project at an angle from the wiper plane so the wiper arm (10) is accessible.

7. Wiper device (1) according to claim 6, wherein the connecting rod levers each feature a snap-in device (17) in order to hold the connecting rod levers (8) in the maintenance position, wherein the connecting rod levers are designed such that they are able to exit the maintenance position by moving the connecting rod levers back into the wiper plane with a restoring force.

8. Wiper device (1) according to claim 1, wherein the fastening parts of the connecting rod levers (8) and/or the connecting rod levers (8) are manufactured of a deep-drawing material.

9. Wiper device (1) according to claim 1, wherein the connecting rod levers (8) are coupled with the wiper arm (10) at the fastening points with a caulked fastening element (16).

10. Wiper device according to claim 1, wherein at least one of the connecting rod levers (8) is provided with a first cross-section in a first section facing the swivel axis and a second smaller cross-section in a second section facing the fastening point in order to adjust the pressure force.

11. Wiper device (1) according to claim 2, wherein the wiper arm is designed to be non-articulated.

12. Wiper device according to claim 11, wherein at least one of the connecting rod levers (8) is pre-stressed in an installed state.

13. Wiper device (1) according to claim 12, wherein the wiper arm (10) is connected to a wiper blade (12) via a swivel joint.

14. Wiper device (1) according to claim 13, wherein the connecting rod levers (8) each feature a fold-out mechanism in order to swivel the wiper arm (10) into a maintenance position so that a wiper blade (12) connected to the wiper arm (10) can be serviced or replaced, wherein the connecting rod levers (8) are designed such that in the maintenance position they are able to project at an angle from the wiper plane so the wiper arm (10) is accessible.

15. Wiper device (1) according to claim 14, wherein the connecting rod levers each feature a snap-in device (17) in order to hold the connecting rod levers (8) in the maintenance position, wherein the connecting rod levers are designed such that they are able to exit the maintenance position by moving the connecting rod levers back into the wiper plane with a restoring force.

16. Wiper device (1) according to claim 15, wherein the fastening parts of the connecting rod levers (8) and/or the connecting rod levers (8) are manufactured of a deep-drawing material.

17. Wiper device (1) according to claim 16, wherein the connecting rod levers (8) are coupled with the wiper arm (10) at the fastening points with a caulked fastening element (16).

18. Wiper device according to claim 17, wherein at least one of the connecting rod levers (8) is provided with a first cross-section in a first section facing the swivel axis and a second smaller cross-section in a second section facing the fastening point in order to adjust the pressure force.
